(19) United States
(12) Patent Application Publication
(10) Pub. No.: US 2025/0036742 A1
(43) Pub. Date: Jan. 30, 2025

(54) METHOD AND APPARATUS FOR LIVENESS DETECTION, ELECTRONIC DEVICE, AND STORAGE MEDIUM

(71) Applicant: MaShang Consumer Finance Co., Ltd., Chongqing (CN)

(72) Inventors: Yue FENG, Chongqing (CN); Pengri HU, Chongqing (CN)

(21) Appl. No.: 18/915,103

(22) Filed: Oct. 14, 2024

(30) Foreign Application Priority Data
Oct. 13, 2023 (CN) 202311331703.8

(51) Int. Cl. G06F 21/36; G06F 3/04845; G06F 9/451

(52) U.S. Cl. CPC G06F 21/36; G06F 3/04845; G06F 9/453

(57) ABSTRACT

Embodiments of the present application provide a method and an apparatus for liveness detection, an electronic device, and a storage medium. The method includes: acquiring data of a user; establishing a binding relationship between the user and a model, where orientation of the model is determined based on the data after the binding relationship is established; controlling movement of a control according to a variation of the orientation of the model, and acquiring first information of the control according to a preset time interval during the movement; and performing liveness detection according to the first information, to obtain a detection result of the user, whereby improving the accuracy of the liveness detection.

### CROSS-REFERENCE TO RELATED APPLICATION

This application claims priority to Chinese Patent Application No. 202311331703.8, filed on Oct. 13, 2023, which is hereby incorporated by reference in its entirety.

### TECHNICAL FIELD

The present application relates to the field of liveness identification technology and, in particular, to a method and an apparatus for liveness detection, an electronic device, and a storage medium.

### BACKGROUND

With the development of electronic technology, the liveness identification technology has been more widely used. The liveness identification technology is a technology to identify whether a user is a real person or a machine. During a common implementation of liveness identification, the user needs to make a corresponding action according to a randomly generated command, to prove that the user, instead of using a pre-recorded video or image data, is participating in the detection in person.

The above-mentioned liveness detection has such limitations: the number of actions is limited, even though a new command is randomly generated every time the liveness detection is performed; the number of optional commands is very small, and they are vulnerable to breaking in an exhaustive manner by a machine of malicious attacks through an injection attack, resulting in that the liveness detection is no longer accurate so that the machine can successfully pass the detection by impersonating the identity of a living person, thereby bringing a great security risk. Therefore, it has become a highly concerned matter currently as to how to improve the accuracy of a method for liveness detection.

### SUMMARY

Embodiments of the present application provide a method and an apparatus for liveness detection, an electronic device and a storage medium, to improve the accuracy of the liveness detection.

In a first aspect, an embodiment of the present application provides a method for liveness detection, including:
acquiring data of a user;
establishing a binding relationship between the user and a model, where orientation of the model is determined based on the data after the binding relationship is established;
controlling movement of a control according to a variation of the orientation of the model, and acquiring first information of the control according to a preset time interval during the movement; and
performing liveness detection according to the first information, to obtain a detection result of the user.

In a second aspect, an embodiment of the present application provides an apparatus for liveness detection, where the apparatus includes:
an acquisition unit, configured to acquire data of a user;
an establishment unit, configured to establish a binding relationship between the user and a model, where orientation of the model is determined based on the data after the binding relationship is established;
a control unit, configured to control movement of a control according to a variation of the orientation of the model, and acquire first information of the control according to a preset time interval during the movement; and
a detection unit, configured to perform liveness detection according to the first information, to obtain a detection result of the user.

In a third aspect, an embodiment of the present application provides an electronic device including: a processor; and a memory configured to store computer-executable instructions, where the computer-executable instructions, when executed, cause the processor to perform the method for liveness detection according to the first aspect.

In a fourth aspect, an embodiment of the present application provides a computer-readable storage medium for storing computer-executable instructions, where the computer-executable instructions, when executed by a processor, implement the method for liveness detection according to the first aspect.

It can be seen that, in the embodiments of the present application, firstly, data of a user is acquired; secondly, a binding relationship between the user and a model is established, where orientation of the model is determined based on the data after the binding relationship is established; then, movement of a control is controlled according to a variation of the orientation of the model, and first information of the control is acquired according to a preset time interval during the movement; finally, liveness detection is performed according to the first information, to obtain a detection result of the user. Therefore, since the binding relationship between the user and the model is established, and the orientation of the model is determined based on the data after the binding relationship is established, the model can move synchronously with the face of the user, and face orientation of the user is completely consistent with face orientation of the model. Then, the movement of the control is controlled according to the variation of the orientation of the model, such that the user can indirectly drive the movement of the control through adjustment to the face orientation and other operations, and since the acquired first information is plural pieces of first information obtained according to the preset time interval, the first information can reflect movement characteristics of the facial movement of the user, such as trajectory, speed, acceleration, etc. Due to physiological limitations of human beings, movement characteristics of a real person are obviously different from those of a machine that impersonates a human being, hence it would be more accurate to determine whether the user is a real person or a machine that impersonates a human being, by performing the liveness detection with the first information.

### BRIEF DESCRIPTION OF DRAWINGS

In order to more clearly illustrate the embodiments of the present application or the technical schemes in the prior art, the drawings needed in the description of the embodiments or the prior art will be briefly introduced below. It is obvious that the accompanying drawings in the following description are intended for some embodiments of the present specification. For those of ordinary skill in the art, other accompanying drawings can be obtained based on these accompanying drawings without any creative effort.

FIG. 1 is a schematic diagram of an implementation environment of a method for liveness detection according to an embodiment of the present application.

FIG. 2 is a processing flow chart of a method for liveness detection according to an embodiment of the present application.

FIG. 3 is a diagram of an application scenario in which liveness detection is performed using a red dot and blue frame mode according to an embodiment of the present application.

FIG. 4 is an example diagram of tiles in a title cutting mode according to an embodiment of the present application.

FIG. 5 is an example diagram of acquiring first information in a method for liveness detection according to an embodiment of the present application.

FIG. 6 is a structural schematic diagram of a liveness detection assembly according to an embodiment of the present application.

FIG. 7 is an interface diagram of a display area of a user terminal according to an embodiment of the present application.

FIG. 8 is a dual-side interaction diagram of a method for liveness detection according to an embodiment of the present application.

FIG. 9 is a module schematic diagram of an apparatus for liveness detection according to an embodiment of the present application.

FIG. 10 is a schematic diagram of an apparatus for liveness detection according to an embodiment of the present application.

FIG. 11 is a structural schematic diagram of an electronic device according to an embodiment of the present application.

### DESCRIPTION OF EMBODIMENTS

In order to make people in the art better understand the technical schemes in the embodiments of the present application, the technical schemes in the embodiments of the present application will be described in the following clearly and comprehensively in conjunction with the accompanying drawings of the present application. It is evident that the described embodiments are intended for some embodiments of the present specification, not all of the embodiments. For those of ordinary skill in the art, all other embodiments obtained by them based on the embodiments of the present application without any creative effort shall fall within the scope of protection of the present application.

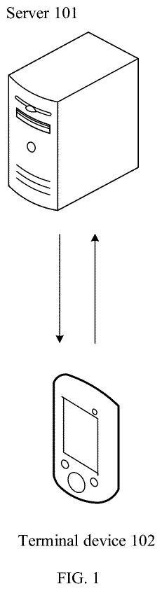

The method for liveness detection according to one or more embodiments of the present specification can be applied to an implementation environment of the method for liveness detection. As shown in FIG. 1, the implementation environment at least includes a server 101 for liveness detection and a terminal device 102 for acquiring data and first information.

The server 101 may be a server, or a server cluster composed of several servers, or one or more cloud servers in a cloud computing platform, and is configured to perform liveness detection.

The terminal device 102 can be a mobile phone, a personal computer, a tablet computer, an e-book reader, a device for information interaction based on VR (Virtual Reality, Virtual Reality), a vehicle-mounted terminal, an Internet of Things (IoT) device, a wearable smart device, a portable laptop computer, a desktop computer or the like. The terminal device 102 can be configured with a client of an application program, the specific form of the client can be an application program, a subroutine within an application program, a service model within an application program, or a web program. The client can acquire data and first information.

In this implementation environment, during the liveness detection, the server 101 receives data of a user that is acquired by the terminal device 102; then, establishes a binding relationship between the user and a model, where orientation of the model is determined based on the data after the binding relationship is established; next, controls movement of a control according to a variation of the orientation of the model, and receives first information of the control acquired by the terminal device 102 according to a preset time interval during the movement; finally, performs liveness detection according to the first information, to obtain a detection result of the user. Therefore, since the binding relationship between the user and the model is established, and the orientation of the model is determined based on the data after the binding relationship is established, the model can move synchronously with the face of the user, and face orientation of the user is completely consistent with face orientation of the model. Then, the movement of the control is controlled according to the variation of the orientation of the model, such that the user can indirectly drive the movement of the control through adjustment to the face orientation and other operations, and since the acquired first information is plural pieces of first information obtained according to the preset time interval, the first information can reflect movement characteristics of the facial movement of the user, such as trajectory, speed, acceleration, etc. Due to physiological limitations of human beings, movement characteristics of a real person are obviously different from those of a machine that impersonates a human being, hence it would be more accurate to determine whether the user is a real person or a machine that impersonates a human being, by performing the liveness detection with the first information.

An embodiment of a method for liveness detection is provided by the present specification:
in many application scenarios, such as teenage addiction prevention, crawler interception, inspection duty and financial verification, it is often necessary to determine through the liveness detection whether a user is a real person or a machine that impersonates a human being. In a common liveness detection, a user needs to make a corresponding action according to a randomly generated instruction. However, the number of actions is limited, then the number of candidate instructions is small, and the defense ability is poor when confronting with attack risks such as duplicate, remake, and injection. Once breaking, the liveness detection is no longer accurate, which may bring a huge security risk. In order to solve the above-described problem, an embodiment of the present application provides a method for liveness detection.

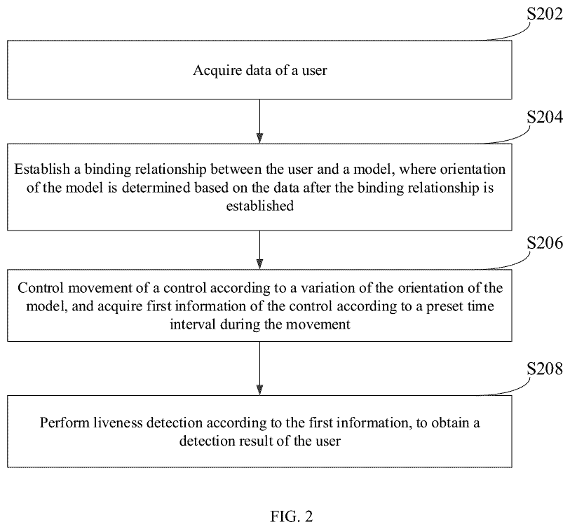

FIG. 2 is a processing flow chart of a method for liveness detection according to an embodiment of the present application. Referring to FIG. 2, the method for liveness detection provided in the embodiment specifically includes steps S202 to S208.

Step S202: acquire data of a user.

The user is a user for whom a determination needs to be made on whether it is a real person or a machine that impersonates a human being.

In a specific implementation, the acquiring the data of the user can be performed by: shooting the user through a data acquisition component having an image acquisition function, to obtain image data containing a face of the user, and determining the data of the user according to the image data.

The data acquisition component can be an image sensor, a camera, or the like.

The data of the user may be data for describing facial information of the user.

Step S204: establish a binding relationship between the user and a model, where orientation of the model is determined based on the data after the binding relationship is established.

The model can be a three-dimensional (3D) model established based on a human face.

In specific implementation, the establishing the binding relationship between the user and the model can be performed by: taking a preset initial position of the model as an original point and taking face orientation of the user when the binding relationship is established as an angle of 0 degree, and establishing a three-dimensional spatial coordinate system corresponding to the model to obtain a first stereo coordinate system.

After the first stereo coordinate system is established, movement information of the model can be finely measured based on the first stereo coordinate system. The movement information includes, but is not limited to, a moving distance, a moving direction, a rotating angle of the model, and so on.

Specifically, when the position of the model does not leave the original point, but the orientation changes, the rotating angle of the orientation of the model can be finely measured based on the first stereo coordinate system.

When the position of the model leaves the original point, but the orientation does not change, the moving direction and moving distance of the model can be finely measured based on the first stereo coordinate system.

When the position of the model leaves the original point and the orientation changes, the moving direction, moving distance and rotating angle of the model can be finely measured based on the first stereo coordinate system.

The original point and the angle of 0 degree are two parameters that are both configured to establish the three-dimensional spatial coordinate system. When the original point and the angle of 0 degree are the same, the three-dimensional spatial coordinate system established based on the original point and the angle of 0 degree is the same coordinate system. When at least one of the original point and the angle of 0 degree is different, the three-dimensional spatial coordinate system established based on the original point and the angle of 0 degree is different.

After the binding relationship between the user and the model is established, the moving direction of the face of the user is the same as the moving direction of the model in the first stereo coordinate system, the moving distance of the face of the user is the same as the moving distance of the model in the first stereo coordinate system, and the rotating angle of the face of the user is the same as the rotating angle of the model in the first stereo coordinate system.

After the binding relationship between the user and the model is established, the data of the user can be transformed into at least one of the moving direction, the moving distance and the rotating angle of the face of the user in a second stereo coordinate system.

It should be emphasized that the movement of the model in the first stereo coordinate system is driven based on the data of the user, and the model will not actively move, nor can it change the behavior of the user.

After the binding relationship is established, the orientation of the model at a certain time point is determined by real-time data of the user that is acquired at this time point. The movement of the model is synchronized with the face movement of the user.

For example, after the binding relationship is established, if the user looks up, the model looks up; if the user looks left, the model looks left, and so on.

The establishment of the first stereo coordinate system in the above way takes into account that movement of an object is relative. For example, taking a train as a reference system, people on the train are motionless; whereas taking roadside trees as the reference system, people on the train are always moving. If modelling is performed by taking the user terminal as the reference system to numerically measure the facial movement of the user, a very biased angle might be derived, which is not conducive to driving the movement of the control through the data in subsequent steps. By contrast, in the first stereo coordinate system with the face orientation of the user being taken as the angle of 0 degree and the position of the model being located at the original point of the first stereo coordinate system, after the first stereo coordinate system is established, the data can be transformed into the movement information of the model in the first stereo coordinate system, to drive the synchronization of the face orientation of the model with the face orientation of the user.

In a specific implementation, the data includes a first position in a display area corresponding to a first point of the user and a second position in the display area corresponding to a second point of the user. The establishing the binding relationship between the user and the model includes: establishing the binding relationship between the user and the model under a circumstance that a face of the user is determined to be of bilateral symmetry according to the data, and the first position and the second position are located in a preset area of the display area.

The data of the user may include: facial image data; the first position in the display area of the user terminal corresponding to a first point of the user; and the second position in the display area of the user terminal corresponding to a second point of the user.

In a specific implementation, it can be decided whether the face of the user is of bilateral symmetry according to the face image data, and whether the first position and the second position are located in the preset area of the display area.

If the face of the user is of no bilateral symmetry, it indicates that the user is not in a state of looking straight at the display area of the user terminal.

If the first position is outside the preset area of the display area, it indicates that the user is not in the state of looking straight at the display area of the user terminal.

If the second position is outside the preset area of the display area, it indicates that the user is not in the state of looking straight at the display area of the user terminal.

If the face of the user is of bilateral symmetry, the first position is located in the preset area of the display area, and the second position is located in the preset area of the display area, then it indicates that the user is in the state of looking straight at the display area of the user terminal, so that the binding relationship between the user and the model can be established.

In addition, under a circumstance that the face of the user is determined to be of bilateral symmetry according to the data, and that the first position and the second position are located in the preset area of the display area, it is also possible to determine that the user is in the state of looking straight at a screen, and detect a duration at which the user is in the state of looking straight at the screen, to obtain a looking straight duration. When the looking straight duration is greater than a preset duration threshold, it is determined that the binding relationship between the user and the model can be established.

In a specific implementation, the data includes a third position in the display area of the user terminal corresponding to a third point. The establishing the binding relationship between the user and the model includes: establishing the binding relationship between the user and the model under a circumstance that the third position and the initial position of the control are located in a same second area.

The method for liveness detection can be applied to the user terminal, and the display area of the user terminal is pre-divided into a plurality of second areas.

For example, the display area of the user terminal is pre-divided into 50×25=1250 second areas, that is, the 1250 second areas are arranged in 50 rows and 25 columns.

In specific implementation, a variety of liveness detection modes can be pre-configured, for example:

### (a1) a Red Dot and Blue Frame Mode

The red dot and blue frame mode refers to a mode in which the liveness detection is performed by controlling a red dot to move into a blue round frame.

It should be noted that “red” and “blue” in the red dot and blue frame mode are only exemplary colors and can be replaced by any colors, while “dot” and “frame” are only exemplary expressions and can be replaced by any expressions.

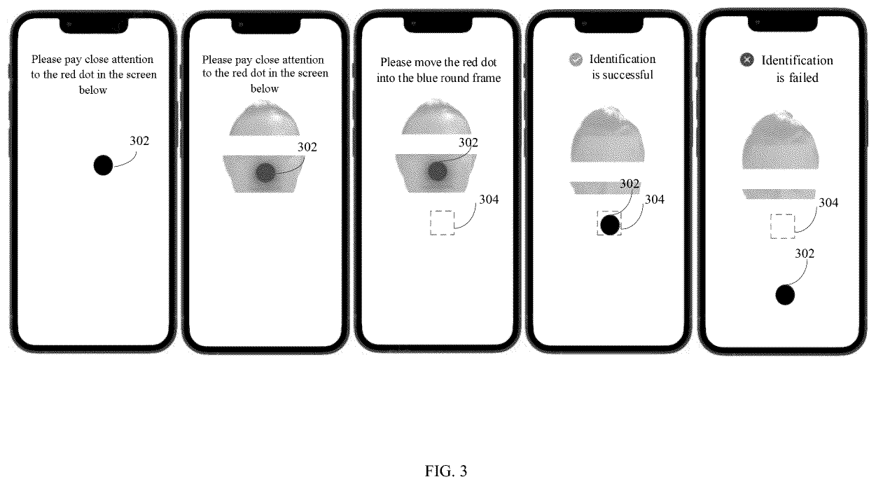

FIG. 3 is a diagram of an application scenario in which liveness detection is performed using a red dot and blue frame mode according to an embodiment of the present application.

As shown in FIG. 3, at first, “Please pay close attention to the red dot in the screen below” is displayed in a display area of a user terminal, to prompt the user to look at the red dot 302 in the display area.

Then, “Please move the red dot into the blue round frame” is displayed in the display area of the user terminal, to prompt the user to drive the movement of the red dot 302 into the blue round frame 304.

Under a circumstance that the red dot 302 is moved into the blue round frame 304, a detection result is that the identification is successful, that is, it is determined that the user is a real person rather than a machine.

Under a circumstance that the red dot 302 is moved away from the blue round frame 304, the detection result is that the identification is failed, that is, it is impossible to determine that the user is a real person.

### (a2) a Title Cutting Mode

The title cutting mode refers to a mode in which the liveness detection is performed by moving, to a designated area, a partial title pre-cut from a title at the designated area.

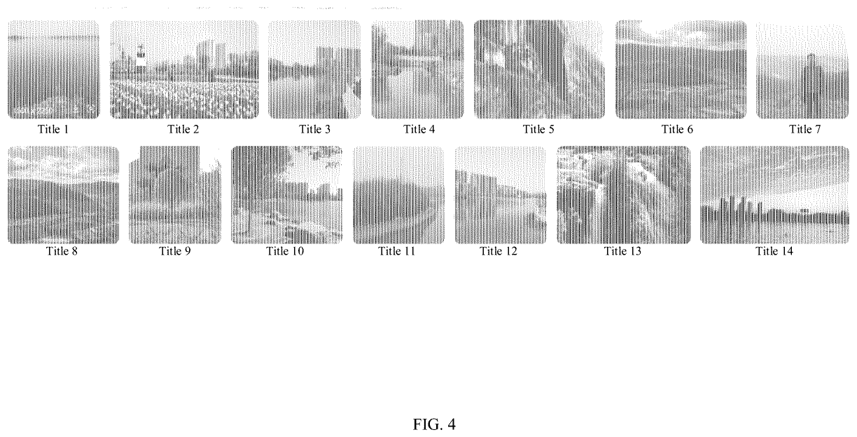

FIG. 4 is a title example diagram of a title cutting mode according to an embodiment of the present application.

FIG. 4 shows 14 kinds of titles, including title 1, title 2 . . . and title 14.

In the process of the liveness detection, when receiving a liveness detection request, a server can randomly select one of the 14 kinds of titles as a target title corresponding to the liveness detection request.

After determining the target title, the server can randomly determine a cutting position and a cutting size in the target title, and cut the title based on the cutting position and the cutting size to obtain a residual target title after the cutting process and a partial title cut from the target title. After the cutting processing, there is a blank area at the cutting position in the residual target title, and the size and shape of the blank area are the same as those of the partial title.

The server sends first image information of the residual target title and second image information of the partial title to a user terminal, and the user terminal performs page rendering based on the first image information and the second image information, to obtain a target page.

The residual target title, the partial title and prompt information are displayed in the target page, and the prompt information is used to prompt the user to move the partial title from a preset initial position to the blank area in the residual target title.

In the case that the partial title is moved into the blank area, a detection result is that the identification is successful, that is, it is determined that the user is a real person rather than a machine.

In the case that the partial title is moved away from the blank area, the detection result is that the identification is failed, that is, it is impossible to determine that the user is a real person.

In the above-mentioned various liveness detection modes, it is necessary to move a designated object to a designated area. For example, in the red dot and blue frame mode, the designated object is the red dot and the designated area is inside of the blue frame mode; in the title cutting mode, the designated object is the partial title, and the designated area is the blank area in the residual target title.

In the embodiment, in order to drive the designated object to move, a control having a corresponding relationship with the designated object can be pre-configured.

Illustratively, the control may be a slider.

The moving direction of the control is the same as the moving direction of the designated object in the display area of the user terminal, and the moving distance of the control may be the same as the moving distance of the designated object in the display area of the user terminal, or there may be a fixed mapping relationship therebetween.

An initial position of the control can be a corresponding initial position of the designated object corresponding to the control in the display area of the user terminal.

Under a circumstance that the number of second areas is multiple, the initial position of the control can be located in one of the second areas.

Under a circumstance that the third position in the display area of the user terminal corresponding to the third point is located in the same second area as the initial position of the control, it indicates that the user is looking at the designated object corresponding to the control, and the binding relationship between the user and the model can be established.

Step S206: control movement of a control according to a variation of the orientation of the model, and acquire first information of the control according to a preset time interval during the movement.

A binding relationship with the control can be pre-established for the model.

The movement information of the control can be measured by a pre-established planar coordinate system.

Under a circumstance that the model keeps still in the first stereo coordinate system, the control remains unchanged in the planar coordinate system.

Under a circumstance that the model rotates in the first stereo coordinate system, that is, the orientation of the model changes, the control moves in the planar coordinate system, and the moving distance and the moving direction are determined by the rotating angle of the model in the first stereo coordinate system.

The controlling the movement of the control according to the variation of the orientation of the model can be performed by: determining the moving distance and the moving direction of the control according to the rotating angle of the model in the first stereo coordinate system, to control the movement of the control based on the moving distance and the moving direction.

Under a circumstance that the control moves, the designated object corresponding to the control moves synchronously in the display area of the user terminal, and the moving direction of the designated object is the same as the moving direction of the control, and the moving distance of the designated object is determined by the moving distance of the control.

The moving distance of the designated object can be the same as the moving distance of the control, and the moving distance of the designated object can also be calculated based on the moving distance of the control and a preset mapping relationship.

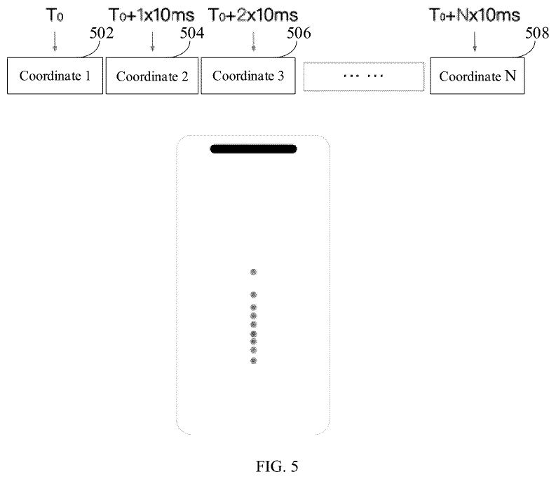

The acquiring the first information of the control according to the preset time interval during the movement can be described with reference to FIG. 5.

FIG. 5 is an example diagram of acquiring first information in a method for liveness detection according to an embodiment of the present application.

As shown in FIG. 5, the preset time interval is 10 ms, coordinate 1 is coordinate 502 of the control acquired at time T₀, coordinate 2 is coordinate 504 of the control acquired at time T₀+1×10 ms, coordinate 3 is coordinate 506 of the control acquired at time T₀+2×10 ms . . . coordinate N is coordinate 508 of the control acquired at time T₀+N×10 ms.

T₀ is a starting time point of the control moving in the planar coordinate system, for example, at time a of month y, day z in year x. Among them, x, y, z and a are all natural numbers greater than or equal to 0.

N is a natural number greater than 0.

In the display area of the user terminal as shown in FIG. 5, the first information of each dot in the display area can be expressed by the coordinate of the control. For example, first information of the uppermost dot in the display area can be represented by the coordinate 502, first information of the second dot in the display area counted from top to bottom can be represented by the coordinate 504, and first information of the third dot in the display area counted from top to bottom can be represented by the coordinate 506, and so on.

In a specific implementation, the controlling the movement of the control according to the variation of the orientation of the model, and the acquiring the first information of the control according to the preset time interval during the movement include: performing Euclidean distance transform processing according to the variation of the orientation of the model, to obtain an offset of the control; and controlling the movement of the control according to the offset of the control.

The euclidean metric (euclidean metric), also known as Euclidean distance, is a commonly used definition of distance, which refers to a real distance between two points in M-dimensional space, or a natural length of a vector (that is, a distance from the point to the original point). Euclidean distance in a two-dimensional space and a three-dimensional space is an actual distance between two points. Among others, m is a natural number greater than 0.

The Euclidean distance transform (Euclidean distance transform) is used to transform a binary image into a gray image, and a gray level of each pixel in the gray image is related to a minimum distance from the pixel to a background pixel. The distance can be transformed between the three-dimensional space and the two-dimensional space through the Euclidean distance transform.

The variation of the orientation of the model can be reflected by the rotating angle of the model in the first stereo coordinate system.

The offset of the control can be used to describe the moving direction and the moving distance of the control in the planar coordinate system.

Based on the Euclidean distance transform, the variation of the orientation of the model in the three-dimensional space can be transformed into the offset of the control in the two-dimensional space.

Furthermore, the control is controlled to move in the planar coordinate system according to the offset, and the designated object corresponding to the control moves synchronously with the control under the circumstance that the control moves.

Step S208: perform liveness detection according to the first information, to obtain a detection result of the user.

Considering that the first information is acquired according to the preset time interval, the plural pieces of first information that are acquired can reflect information such as a moving trajectory, a moving speed and a moving acceleration of the control.

The performing the liveness detection according to the first information, to obtain the detection result of the user can be accomplished by: determining a movement parameter of the control according to the acquired plural pieces of first information and the preset time interval, and determining the detection result of the user according to the movement parameter and a preset parameter threshold.

The movement parameter includes at least one of the moving trajectory, the moving speed and the moving acceleration.

The moving trajectory generated by a real person indirectly driving the movement of the control through the data has the following characteristics: the moving trajectory produced by the real person cannot be completely straight, that is, the moving trajectory cannot be a straight line.

The preset parameter threshold may include a moving speed range threshold and a moving acceleration range threshold.

The moving speed range threshold is used to indicate a maximum value and a minimum value of the moving speed of a real person under the limitation of human physiological factors.

The moving acceleration range threshold is used to indicate a maximum value and a minimum value of the moving acceleration of a real person under human physiological factors.

The moving trajectory generated by the movement of the control driven by a machine can be a straight line.

The detection result of the user may include a first detection result and a second detection result.

The first detection result is used to indicate that the user is a real person rather than a machine.

The second detection result is used to indicate that the user is a machine.

The determining the detection result of the user according to the movement parameter and the preset parameter threshold can be performed by: determining whether the moving trajectory is a straight line; if so, determining that the detection result of the user is the second detection result; if not, determining that the detection result of the user is the first detection result.

The determining the detection result of the user according to the movement parameter and the preset parameter threshold can be performed by: determining whether the moving speed is within the moving speed range threshold; if so, determining that the detection result of the user is the first detection result, if not, determining the detection result of the user is the second detection result.

The determining the detection result of the user according to the movement parameter and the preset parameter threshold can be performed by: determining whether the moving acceleration is within the moving acceleration range threshold; if so, determining that the detection result of the user is the first detection result, if not, determining that the detection result of the user is the second detection result.

In addition, the detection result of the user may also include a third detection result, and the third detection result is used to indicate that it is impossible to determine whether the user is a real person.

It should be noted that the difference between the second detection result and the third detection result lies in that: if the detection result of the user is the second detection result, the user must be a machine, and it is impossible that a real person is identified as a machine due to misoperation; if the detection result of the user is the third detection result, the user may be a real person or a machine, and a re-detection is required or a switch to another liveness detection manner is required, such as manual video verification.

In a specific implementation, the performing the liveness detection according to the first information, to obtain the detection result of the user includes: performing trajectory judgment, speed judgment and acceleration judgment according to the first information, to obtain corresponding judgment results; generating, according to the judgment results, a score of the user; and determining the detection result of the user according to the score and a preset threshold.

The performing the trajectory judgment, the speed judgment and the acceleration judgment according to the first information, to obtain the corresponding judgment results can be accomplished by:
inputting plural pieces of first information into a first expert network in a preset expert network set for performing the trajectory judgment, to obtain a judgment result corresponding to a trajectory judgment, where the plural pieces of first information are sequentially arranged according to an acquiring order;
inputting plural pieces of first information into a second expert network in the preset expert network set for performing the speed judgment, to obtain a judgment result corresponding to a speed judgment; and
inputting plural pieces of first information into a third expert network in the preset expert network set for performing the acceleration judgment, to obtain a judgment result corresponding to an acceleration judgment.

The above-mentioned first expert network is configured to judge whether the moving trajectory is a trajectory of a normal person, which can refer to the aforementioned description of the implementation in which the movement parameter is the moving trajectory.

The above-mentioned second expert network is configured to judge whether the moving speed is a moving speed of a normal person, which can refer to the aforementioned description of the implementation in which the movement parameter is the moving speed.

The above-mentioned third expert network is configured to judge whether the moving acceleration is a moving acceleration of a normal person, which can refer to the aforementioned description of the implementation in which the movement parameter is the moving acceleration.

The generating, according to the judgment results, the score of the user can be accomplished by: performing aggregation processing on the judgment result corresponding to the trajectory judgment, the judgment result of the moving speed and the judgment result of the moving acceleration through an aggregation layer, to obtain an aggregation result; and performing mapping processing on the aggregation result, to obtain the score of the user.

The way of aggregation can be direct summation or weighted summation.

The performing the mapping processing on the aggregation result to obtain the score of the user can be accomplished by performing the mapping processing on the aggregation result through a Softmax function to obtain the score of the user.

The Softmax function, that is a normalized exponential function, can be used to “compress” a K-dimensional vector z containing any real number into another K-dimensional real vector σ(z), so that each element has a range between (0,1) and a sum of all elements is 1. K is a natural number greater than 0.

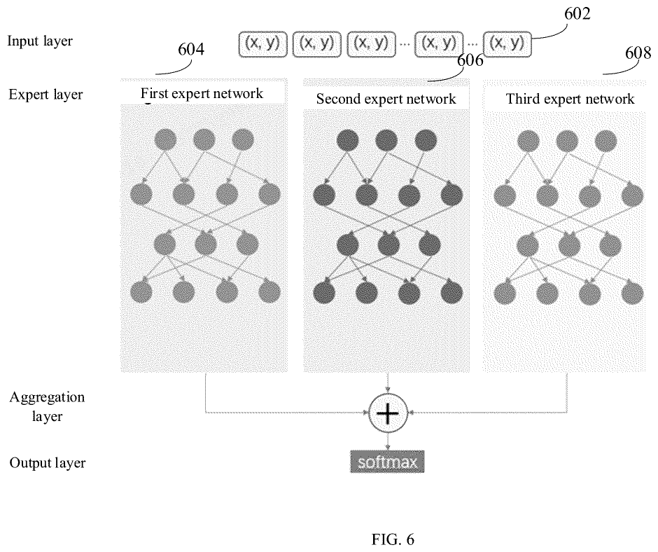

FIG. 6 is a structural schematic diagram of a liveness detection assembly according to an embodiment of the present application.

As shown in FIG. 6, input data of an input layer is first information 602 of the control. An expert layer includes a first expert network 604, a second expert network 606 and a third expert network 608.

The first information 602 is input into the first expert network 604 for performing trajectory judgment, and a judgment result corresponding to a trajectory judgment is obtained.

The first information 602 is input into the second expert network 606 for performing speed judgment, and a judgment result corresponding to a speed judgment is obtained.

The first information 602 is input into the third expert network 608 for performing acceleration judgment, and a judgment result corresponding to an acceleration judgment is obtained.

Then, the judgment result corresponding to the trajectory judgment, the judgment result corresponding to the speed judgment and the judgment result corresponding to the acceleration judgment are aggregated over an aggregation layer to obtain an aggregation result, and mapping processing is performed on the aggregation result through a Softmax function in an output layer to obtain a score.

The higher the score, the higher the possibility that the user is a real person. The lower the score, the higher the possibility that the user is a machine.

The determining the detection result of the user according to the score and the preset threshold can be performed by: comparing the score with the preset threshold in terms of their values, to obtain a comparison result; if the comparison result indicates that the score is greater than or equal to the preset threshold, determining that the detection result of the user is the first detection result; if the comparison result indicates that the score is less than the preset threshold, determining that the detection result of the user is the second detection result.

In a specific implementation, before the controlling the movement of the control according to the variation of the orientation of the model, and the acquiring the first information of the control according to the preset time interval during the movement, the method for liveness detection further includes: displaying second information in a display area of a user terminal, where the second information is used to guide the user to control the movement of the control into a first area; the performing the liveness detection according to the first information, to obtain the detection result of the user includes: under a circumstance that lastly acquired first information of the control is located in the first area, performing the liveness detection according to the first information, to obtain the detection result of the user.

The method for liveness detection can be applied to a user terminal, and a display area of the user terminal is pre-divided into a plurality of second areas. A first area is one of the plurality of second areas.

An action liveness detection refers to detection of whether a user is a real person by guiding the user to perform a randomly determined action. The randomly determined action can be one of a variety of preset actions, for example, blink, look left, open your mouth, shake your head up and down, and so on.

According to the method for liveness detection provided in the embodiment, the display area of the user terminal is pre-divided into a plurality of second areas, and the server needs to randomly select one of the plurality of second areas as a first area, and generate second information carrying area identification information of the first area and send it to the user terminal. The second information is used to guide the user to control the control to move into the first area.

In the above-mentioned action liveness detection, the number of various preset actions is small, and it is easy to break in an exhaustive way through injection attack because of the limited combination of actions. Compared with the action liveness detection, the method for liveness detection according to the embodiment makes full use of an infinite segmentation of a gaze area in the display area of the user terminal, to design the display area into a large number of gaze units according to panes and step sizes, which obviously increases the command complexity and has better ability to defend against injection attacks.

Under a circumstance that lastly acquired first information of the control is located in the first area, it indicates that the control is moved into the first area, the movement operation may be driven based on data of a real person or driven by a machine of malicious attacks.

A basic condition to complete the liveness detection is such that the control is moved into the first area. Under a circumstance that this basic condition is met, the liveness detection is performed according to the first information, to obtain the detection result of the user.

Under a circumstance that lastly acquired first information is located outside the first area, it indicates that the control has not been moved into the first area. This situation may be caused by a misoperation from the user, or an initiative interruption of the liveness detection from the user, and so on. In this case, it can be determined that the detection result of the user is the third detection result, that is, it is impossible to determine whether the user is a real person.

In a specific implementation, the display area of the user terminal is pre-divided into a first partition and a second partition, the first partition includes a plurality of second areas, and the second partition includes a plurality of second areas, and a preset spacing distance exists between the first partition and the second partition; an initial position of the control is located in one of the first partition and the second partition, and the first area is located in the other one of the first partition and the second partition.

The first partition and the second partition may be two partitions in the display area of the user terminal that have no overlap.

The first partition may include a plurality of second areas. The second partition may include a plurality of second areas. The number of second areas included in the first partition and the number of second areas included in the second partition may be the same or different.

The shape of the first partition and the shape of the second partition may be the same or different.

The size of the first partition and the size of the second partition may be the same or different.

The words “first” and “second” in the first partition and the second partition are only for the convenience of distinguishing two different partitions and have no practical meaning.

The first partition can be located directly above the second partition, the first partition can be located directly on the left of the second partition, and the first partition can be located on the upper left of the second partition, and so on. The embodiment of the present application does not impose special restrictions on the positional relationship between the first partition and the second partition.

The first partition being located directly above the second partition is used as an example, the preset spacing distance may be a spacing between a bottom of the first partition and a top of the second partition.

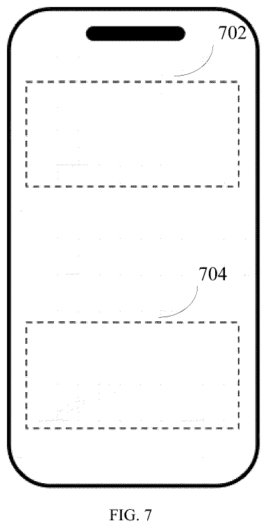

Next, this implementation can be exemplified with reference to FIG. 7. FIG. 7 is an interface diagram of a display area of a user terminal according to an embodiment of the present application.

As shown in FIG. 7, a display area of a user terminal is divided into a first partition 702 and a second partition 704, and there is a preset spacing distance between the first partition 702 and the second partition 704.

In the user terminal shown in FIG. 7, the following two situations may occur:
(1) an initial position of a control is located in the first partition 702, and a first area is located in the second partition 704;
(2) the initial position of the control is located in the second partition 704, and the first area is located in the first partition 702.

The purpose of pre-dividing the first partition and the second partition with the preset spacing distance therebetween is to keep a distance between the initial position of the control and the first area. Considering that the initial position of the control can be a preset fixed position, and that the first area can be randomly determined in a plurality of second areas, the distance between the initial position and the first area is random. If the distance between the initial position and the first area is too small, it is possible that the facial rotation amplitude of the user when controlling the movement of the control would be too small. Therefore, the initial position of the control is set in one of the first partition and the second partition, and the first area is set in the other one of the first partition and the second partition, such that the facial rotation amplitude of the user when controlling the movement of the control is not too small, therefore the operation friendliness is improved.

In the embodiment shown in FIG. 2, firstly, data of a user is acquired; secondly, a binding relationship between the user and a model is established, where orientation of the model is determined based on the data after the binding relationship is established; then, movement of a control is controlled according to a variation of the orientation of the model, and first information of the control is acquired according to a preset time interval during the movement; finally, liveness detection is performed according to the first information, to obtain a detection result of the user. Therefore, since the binding relationship between the user and the model is established, and the orientation of the model is determined based on the data after the binding relationship is established, the model can move synchronously with the face of the user, and face orientation of the user is completely consistent with face orientation of the model. Then, the movement of the control is controlled according to the variation of the orientation of the model, such that the user can indirectly drive the movement of the control through adjustment to the face orientation and other operations, and since the acquired first information is plural pieces of first information obtained according to the preset time interval, the first information can reflect movement characteristics of the facial movement of the user, such as trajectory, speed, acceleration, etc. Due to physiological limitations of human beings, movement characteristics of a real person are obviously different from those of a machine that impersonates a human being, hence it would be more accurate to determine whether the user is a real person or a machine that impersonates a human being, by performing the liveness detection with the first information.

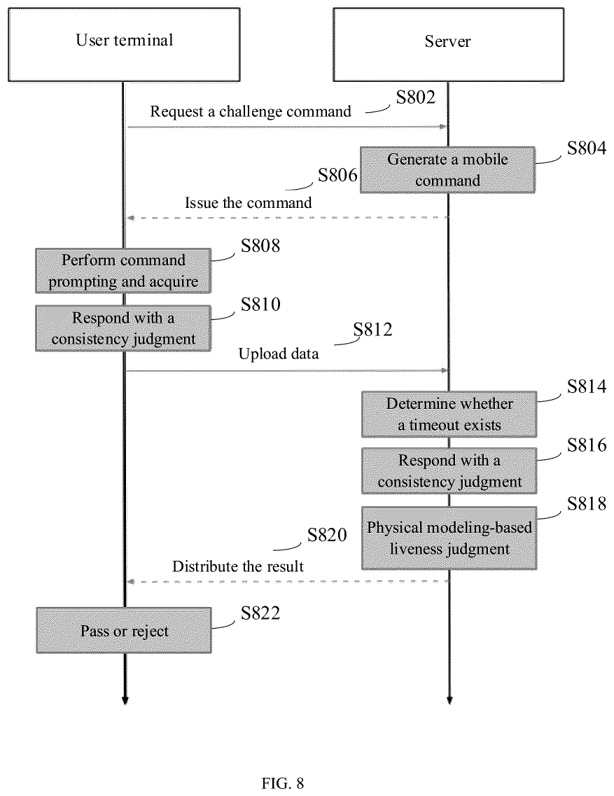

Under the same technical concept, the present specification further provides another method for liveness detection. FIG. 8 is a dual-side interaction diagram of a method for liveness detection according to an embodiment of the present application.

Step S802: request a challenge command.

A user triggers a user terminal to send a liveness detection request to a server, and the liveness detection request can be used to trigger the server to randomly generate a challenge command.

Step S804: generate a mobile command.

Step S806: issue the command.

The server randomly generates command information in response to the liveness detection request and returns it to the user terminal. Specifically, the server randomly selects an appropriate command base map and an appropriate command position and sends them to the user terminal, and starts to count down the life cycle of the command.

Step S808: perform command prompting and acquiring.

The user terminal renders corresponding second information according to the obtained command information, acquires data of the user, and sends the data to the server.

Step S810: respond with a consistency judgment.

Step S812: upload data.

Step S814: determine whether a timeout exists.

When receiving the data, the server first checks whether the current command is still within a validity period which is determined by the life cycle. If it is not within the validity period, the liveness detection is rejected and the user is prompted to trigger a liveness detection request again. If it is within the validity period, a further check is made as to whether the data is consistent with the command.

Step S816: respond with a consistency judgment.

Step S818: physical modeling-based liveness judgment.

In this step, reference may be made to the corresponding description of the implementation in the embodiment of FIG. 2, “performing trajectory judgment, speed judgment and acceleration judgment according to the first information, to obtain corresponding judgment results; generating, according to the judgment results, a score of the user; and determining the detection result of the user according to the score and a preset threshold”.

Step S820: distribute the result.

Step S822: pass or reject.

Under a circumstance that the detection result is a first detection result, let the user pass, so that the user can perform the subsequent operation.

Under a circumstance that the detection result is a second detection result or a third detection result, the user is rejected for performing the subsequent operation.

Due to the same technical concept, the description in the embodiment is relatively simple, and reference can be made to the corresponding description of the foregoing method embodiment for relevant parts.

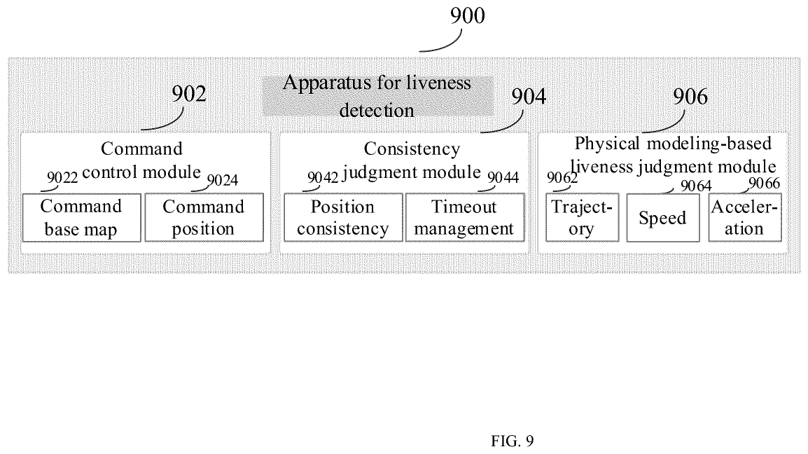

FIG. 9 is a module schematic diagram of an apparatus for liveness detection according to an embodiment of the present application. The apparatus 900 for liveness detection shown in FIG. 9 can perform the method for liveness detection according to the aforementioned method embodiment.

The apparatus 900 for liveness detection includes a command control module 902, a consistency judgment module 904 and a physical modeling-based liveness judgment module 906.

The command control module 902 can be configured to determine a command base map 9022 and a command position 9024. The consistency judgment module 904 can be configured to check whether a position of a control controlled by a user behavior and the command position 9024 meet a position consistency 9042, and the consistency judgment module 904 can further be configured for timeout management 9044. The physical modeling-based liveness judgment module 906 can be configured to determine a trajectory 9062, a speed 9064 and an acceleration 9066 of the control.

Due to the same technical concept, the description in the embodiment is relatively simple, reference may be made to the corresponding description of the foregoing method embodiment for relevant parts.

In the above-described embodiment, a method for liveness detection is provided. Correspondingly, based on the same technical concept, an embodiment of the present application further provides an apparatus for liveness detection, which will be described below with reference to the accompanying drawings.

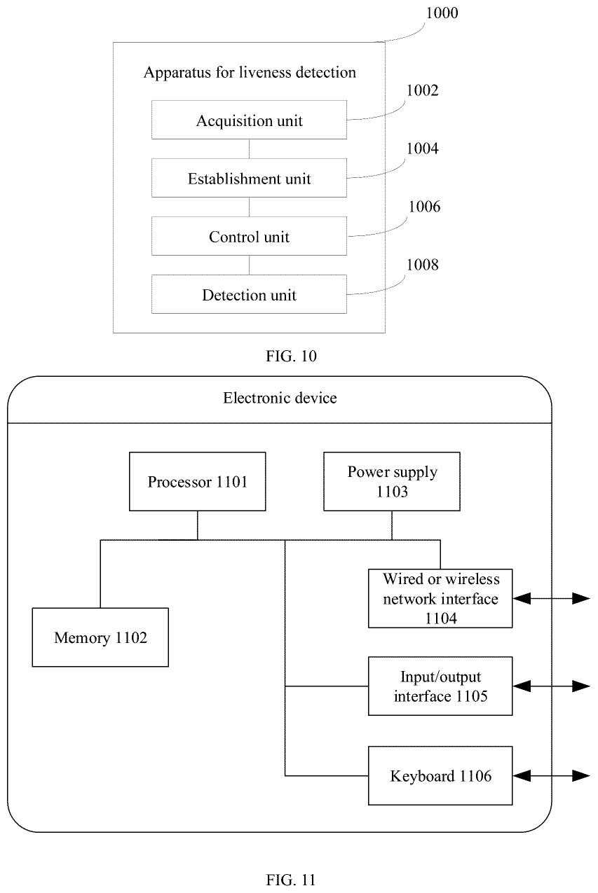

FIG. 10 is a schematic diagram of an apparatus for liveness detection according to an embodiment of the present application.

The embodiment provides an apparatus 1000 for liveness detection, including:
an acquisition unit 1002, configured to acquire data of a user;
an establishment unit 1004, configured to establish a binding relationship between the user and a model, where orientation of the model is determined based on the data after the binding relationship is established;
a control unit 1006, configured to control movement of a control according to a variation of the orientation of the model, and acquire first information of the control according to a preset time interval during the movement; and
a detection unit 1008, configured to perform liveness detection according to the first information, to obtain a detection result of the user.

In an implementation, the control unit 1006 is specifically configured to:
perform Euclidean distance transform processing according to the variation of the orientation of the model, to obtain an offset of the control; and
control the movement of the control according to the offset of the control.

In an implementation, the detection unit 1008 is specifically configured to:
perform trajectory judgment, speed judgment and acceleration judgment according to the first information, to obtain corresponding judgment results;
generate, according to the judgment results, a score of the user; and
determine the detection result of the user according to the score and a preset threshold.

In an implementation, the apparatus 1000 for liveness detection further includes:
a display unit, configured to display second information in a display area of a user terminal, where the second information is used to guide the user to control the movement of the control into a first area;
where the detection unit 1008 is specifically configured to:
under a circumstance that lastly acquired first information of the control is located in the first area, perform the liveness detection according to the first information, to obtain the detection result of the user.

In an implementation, the display area of the user terminal is pre-divided into a first partition and a second partition, the first partition includes a plurality of second areas, and the second partition includes a plurality of second areas, and a preset spacing distance exists between the first partition and the second partition; an initial position of the control is located in one of the first partition and the second partition, and the first area is located in the other one of the first partition and the second partition.

In an implementation, the data includes a first position in a display area corresponding to a first point of the user and a second position in the display area corresponding to a second point of the user. The establishment unit 1004 is specifically configured to:
establish the binding relationship between the user and the model under a circumstance that a face of the user is determined to be of bilateral symmetry according to the data, and the first position and the second position are located in a preset area of the display area.

In an implementation, the data includes a third position in the display area of the user terminal corresponding to a third point. The establishment unit 1004 is specifically configured to:
establish the binding relationship between the user and the model under a circumstance that the third position and the initial position of the control are located in a same second area.

The apparatus for liveness detection provided in the embodiment of the present application includes: an acquisition unit, configured to acquire data of a user; an establishment unit, configured to establish a binding relationship between the user and a model, where orientation of the model is determined based on the data after the binding relationship is established; a control unit, configured to control movement of a control according to a variation of the orientation of the model, and acquire first information of the control according to a preset time interval during the movement; and a detection unit, configured to perform liveness detection according to the first information, to obtain a detection result of the user. Therefore, since the binding relationship between the user and the model is established, and the orientation of the model is determined based on the data after the binding relationship is established, the model can move synchronously with the face of the user, and face orientation of the user is completely consistent with face orientation of the model. Then, the movement of the control is controlled according to the variation of the orientation of the model, such that the user can indirectly drive the movement of the control through adjustment to the face orientation and other operations, and since the acquired first information is plural pieces of first information obtained according to the preset time interval, the first information can reflect movement characteristics of the facial movement of the user, such as trajectory, speed, acceleration, etc. Due to physiological limitations of human beings, movement characteristics of a real person are obviously different from those of a machine that impersonates a human being, hence it would be more accurate to determine whether the user is a real person or a machine that impersonates a human being, by performing the liveness detection with the first information.

Based on the same technical concept, an embodiment of the present application further provides an electronic device corresponding to the above-described method for liveness detection, and the electronic device is configured to execute the above-mentioned method for liveness detection. FIG. 11 is a structural schematic diagram of an electronic device according to an embodiment of the present application.

As shown in FIG. 11, the electronic device may vary greatly due to different configurations or performances, and may include one or more processors 1101 and a memory 1102, where one or more storage applications or data may be stored in the memory 1102. The memory 1102 can be a temporary storage or a permanent storage. An application program stored in the memory 1102 may include one or more modules (not shown), and each module may include a series of computer-executable instructions in the electronic device. Further, the processor 1101 may be configured to communicate with the memory 1102 and execute a series of computer-executable instructions in the memory 1102 on an electronic device. The electronic device may also include one or more power supplies 1103, one or more wired or wireless network interfaces 1104, one or more input/output interfaces 1105, one or more keyboards 1106, etc.

In a specific embodiment, the electronic device includes a memory and one or more programs, where the one or more programs are stored in the memory, and the one or more programs may include one or more modules, and each module may include a series of computer-executable instructions for the electronic device, and the one or more programs configured to be executed by one or more processors include computer-executable instructions to:
acquire data of a user;
establish a binding relationship between the user and a model, where orientation of the model is determined based on the data after the binding relationship is established;
control movement of a control according to a variation of the orientation of the model, and acquire first information of the control according to a preset time interval during the movement; and
perform liveness detection according to the first information, to obtain a detection result of the user.

An embodiment of a computer-readable storage medium provided in the present specification is as follows:
based on the same technical concept, the embodiment of the present application also provides a computer-readable storage medium corresponding to the method for liveness detection described above.

The computer-readable storage medium provided in the embodiment is configured to store computer-executable instructions, where the computer-executable instructions, when executed by a processor, implement the following processes:
acquiring data of a user;
establishing a binding relationship between the user and a model, where orientation of the model is determined based on the data after the binding relationship is established;
controlling movement of a control according to a variation of the orientation of the model, and acquiring first information of the control according to a preset time interval during the movement; and
performing liveness detection according to the first information, to obtain a detection result of the user.

It should be noted that the embodiment of the computer-readable storage medium in the present specification is based on the same inventive concept as the embodiment of the method for liveness detection in the present specification, and for the specific implementation of the embodiment, reference can be made to the implementation of the corresponding method mentioned above, and details will not be described here again.

The specific embodiments of the present specification have been described above. Other embodiments are within the scope of the appended claims. In some cases, the actions or steps recited in the claims may be performed in a different order from that in the embodiments and still achieve the desired results. In addition, the processes depicted in the drawings do not necessarily require the specific order shown or the sequential order to achieve the desired results. In some embodiments, multitasking and parallel processing are also possible or may be advantageous.

It should be understood by those skilled in the art that embodiments of the present application can be provided as a method, a system or a computer program product. Therefore, embodiments of the present application may take the form of an entirely hardware embodiment, an entirely software embodiment, or an embodiment combining software and hardware aspects. Moreover, the present specification can take the form of a computer program product implemented on one or more computer-readable storage media (including but not limited to a disk storage, a CD-ROM, an optical storage, etc.) containing computer usable program codes.

The present specification is described with reference to a flowchart and/or a block diagram of a method, an apparatus (system), and a computer program product according to embodiments of the present specification. It should be understood that each flow and/or block in the flowchart and/or block diagram, and combinations of the flow and/or block in the flowchart and/or block diagram can be implemented by computer program instructions. These computer program instructions may be provided to a processor of a general-purpose computer, a special-purpose computer, an embedded processor or other programmable apparatuses to produce a machine, such that the instructions executed by the processor of the computer or other programmable apparatuses produce an apparatus for implementing the functions designated in one or more flows of the flowchart and/or one or more blocks of the block diagram.

These computer program instructions may also be stored in a computer-readable memory that can direct a computer or other programmable apparatuses to operate in a particular manner, such that the instructions stored in the computer-readable memory produce an article of manufacture including instruction apparatus that implement the functions designated in one or more flows of the flowchart and/or one or more blocks of the block diagram.

These computer program instructions may also be loaded onto a computer or other programmable apparatuses, such that a series of operational steps are performed on the computer or other programmable apparatuses to produce a computer-implemented process, such that the instructions executed on the computer or other programmable apparatuses provide steps for implementing the functions designated in one or more flows of the flowchart and/or one or more blocks of the block diagram.

In a typical configuration, a computing device includes one or more processors (CPU), an input/output interface, a network interface, and a memory.

The memory may include a non-permanent memory, a random-access memory (RAM) and/or a nonvolatile memory of a computer-readable medium, such as a read-only memory (ROM) or a flash memory (flash RAM). The memory is an example of a computer-readable medium.

A computer-readable medium, including a permanent medium and a non-permanent medium, a mobile medium and a non-mobile medium, can store information by any method or technology. Information can be a computer-readable instruction, data structure, module of a program or other data. Examples of the storage medium for computers include, but not limited to, a phase-change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), a digital versatile disc (DVD) or other optical storage, and a magnetic cassette, a magnetic disk storage or other magnetic storage devices or any other non-transmission medium, used for storing information that can be accessed by a computing device. According to the definition in this specification, the computer-readable medium does not include transitory computer-readable media (transitory media), such as a modulated data signal and a carrier wave.

It should also be noted that the terms “including”, “containing” or any other variation thereof are intended to cover non-exclusive inclusion, so that a process, method, commodity or device including a series of elements includes not only those elements, but also other elements not explicitly listed, or elements inherent to such process, method, commodity or device. Without more restrictions, an element defined by the phrase “including a . . . ” does not exclude the existence of other identical elements in the process, method, commodity or device including the elements.

Embodiments of the present application may be described in the general context of computer-executable instructions, such as a program module, being executed by a computer. Generally, the program module includes a routine, program, object, component, data structure, etc. that perform a particular task or implement particular abstract data type. One or more embodiments of the present specification may also be practiced in distributed computing environments where tasks are performed by a remote processing device that is connected through a communication network. In a distributed computing environment, a program module may be located in a local and remote computer storage medium including a storage device.

The embodiments in the present specification are described in a progressive way, and cross reference can be made thereto for the same and similar parts between the embodiments, and each embodiment focuses on the differences from other embodiments. Especially, for the system embodiment, because it is basically similar to a method embodiment, the description is relatively simple, and for the relevant part, reference can be made to to part of the description of the method embodiment.

The above descriptions are only embodiments of this document, and they are not to limit this document. Various modifications and variations are possible to those skilled in the art. Any modification, equivalent substitution, improvement, etc. made within the spirit and principle of this document shall be included in the scope of the claims of this document.

What is claimed is:

1. A method for liveness detection, comprising:
acquiring data of a user;
establishing a binding relationship between the user and a model, wherein orientation of the model is determined based on the data after the binding relationship is established;
controlling movement of a control according to a variation of the orientation of the model, and acquiring first information of the control according to a preset time interval during the movement; and
performing liveness detection according to the first information, to obtain a detection result of the user.

2. The method according to claim 1, wherein the controlling the movement of the control according to the variation of the orientation of the model, and the acquiring the first information of the control according to the preset time interval during the movement comprise:
performing Euclidean distance transform processing according to the variation of the orientation of the model, to obtain an offset of the control; and
controlling the movement of the control according to the offset of the control.

3. The method according to claim 1, wherein the performing the liveness detection according to the first information, to obtain the detection result of the user comprises:
performing trajectory judgment, speed judgment and acceleration judgment according to the first information, to obtain corresponding judgment results;
generating, according to the judgment results, a score of the user; and
determining the detection result of the user according to the score and a preset threshold.

4. The method according to claim 1, wherein before the controlling the movement of the control according to the variation of the orientation of the model, and the acquiring the first information of the control according to the preset time interval during the movement, the method further comprises:
displaying second information in a display area of a user terminal, wherein the second information is used to guide the user to control the movement of the control into a first area;
the performing the liveness detection according to the first information, to obtain the detection result of the user comprises:
under a circumstance that lastly acquired first information of the control is located in the first area, performing the liveness detection according to the first information, to obtain the detection result of the user.

5. The method according to claim 4, wherein the display area of the user terminal is pre-divided into a first partition and a second partition, the first partition comprises a plurality of second areas, and the second partition comprises a plurality of second areas, and a preset spacing distance exists between the first partition and the second partition; an initial position of the control is located in one of the first partition and the second partition, and the first area is located in the other one of the first partition and the second partition.

6. The method according to claim 1, wherein the data comprises a first position in a display area corresponding to a first point of the user and a second position in the display area corresponding to a second point of the user;
the establishing the binding relationship between the user and the model comprises:
establishing the binding relationship between the user and the model under a circumstance that a face of the user is determined to be of bilateral symmetry according to the data, and the first position and the second position are located in a preset area of the display area.

7. The method according to claim 5, wherein the data comprises a third position in the display area of the user terminal corresponding to a third point; the establishing the binding relationship between the user and the model comprises:
establishing the binding relationship between the user and the model under a circumstance that the third position and the initial position of the control are located in a same second area.

8. An apparatus for liveness detection, comprising:
a processor and a memory in communication connection with the processor;
wherein the memory stores computer-executable instructions; and
the processor, when executing the computer-executable instructions stored in the memory, is configured to:
acquire data of a user;
establish a binding relationship between the user and a model, wherein orientation of the model is determined based on the data after the binding relationship is established;
control movement of a control according to a variation of the orientation of the model, and acquire first information of the control according to a preset time interval during the movement; and
perform liveness detection according to the first information, to obtain a detection result of the user.

9. The apparatus according to claim 8, wherein the processor is configured to:
perform Euclidean distance transform processing according to the variation of the orientation of the model, to obtain an offset of the control; and
control the movement of the control according to the offset of the control.

10. The apparatus according to claim 8, wherein the processor is configured to:
perform trajectory judgment, speed judgment and acceleration judgment according to the first information, to obtain corresponding judgment results;
generate, according to the judgment results, a score of the user; and
determine the detection result of the user according to the score and a preset threshold.

11. The apparatus according to claim 8, wherein the processor is configured to:
display second information in a display area of a user terminal, wherein the second information is used to guide the user to control the movement of the control into a first area; and
under a circumstance that lastly acquired first information of the control is located in the first area, perform the liveness detection according to the first information, to obtain the detection result of the user.

12. The apparatus according to claim 11, wherein the display area of the user terminal is pre-divided into a first partition and a second partition, the first partition comprises a plurality of second areas, and the second partition comprises a plurality of second areas, and a preset spacing distance exists between the first partition and the second partition; an initial position of the control is located in one of the first partition and the second partition, and the first area is located in the other one of the first partition and the second partition.

13. The apparatus according to claim 8, wherein the data comprises a first position in a display area corresponding to a first point of the user and a second position in the display area corresponding to a second point of the user;
the processor is configured to:
establish the binding relationship between the user and the pre-established model under a circumstance that a face of the user is determined to be of bilateral symmetry according to the data, and the first position and the second position are located in a preset area of the display area.

14. The apparatus according to claim 12, wherein the data comprises a third position in the display area of the user terminal corresponding to a third point; the processor is configured to:
establish the binding relationship between the user and the pre-established model under a circumstance that the third position and the initial position of the control are located in a same second area.

15. A non-transitory computer-readable storage medium configured to store computer-executable instructions, wherein a processor, when executing the computer-executable instructions, is configured to perform the following operations:
acquiring data of a user;
establishing a binding relationship between the user and a pre-established model, wherein orientation of the model is determined based on the data after the binding relationship is established;
controlling movement of a control according to a variation of the orientation of the model, and acquiring first information of the control according to a preset time interval during the movement; and
performing liveness detection according to the first information, to obtain a detection result of the user.

16. The non-transitory computer-readable storage medium according to claim 15, wherein the processor is configured to execute the following operations:
performing Euclidean distance transform processing according to the variation of the orientation of the model, to obtain an offset of the control; and
controlling the movement of the control according to the offset of the control.

17. The non-transitory computer-readable storage medium according to claim 15, wherein the processor is configured to execute the following operations:
performing trajectory judgment, speed judgment and acceleration judgment according to the first information, to obtain corresponding judgment results;
generating, according to the judgment results, a score of the user; and
determining the detection result of the user according to the score and a preset threshold.

18. The non-transitory computer-readable storage medium according to claim 15, wherein the processor is configured to execute the following operations:
displaying second information in a display area of a user terminal, wherein the second information is used to guide the user to control the movement of the control into a first area; and
under a circumstance that lastly acquired first information of the control is located in the first area, performing the liveness detection according to the first information, to obtain the detection result of the user.

19. The non-transitory computer-readable storage medium according to claim 18, wherein the display area of the user terminal is pre-divided into a first partition and a second partition, the first partition comprises a plurality of second areas, and the second partition comprises a plurality of second areas, and a preset spacing distance exists between the first partition and the second partition; an initial position of the control is located in one of the first partition and the second partition, and the first area is located in the other one of the first partition and the second partition.

20. The non-transitory computer-readable storage medium according to claim 15, wherein the data comprises a first position in a display area corresponding to a first point of the user and a second position in the display area corresponding to a second point of the user;
the processor is configured to execute the following operation:
establishing the binding relationship between the user and the pre-established model under a circumstance that a face of the user is determined to be of bilateral symmetry according to the data, and the first position and the second position are located in a preset area of the display area.
